(19) United States
(12) Patent Application Publication
(10) Pub. No.: US 2026/0069491 A1
(43) Pub. Date: Mar. 12, 2026

(54) Shoulder and neck massager

(71) Applicant: SKG Health Technologies Co., Ltd., Shenzhen (CN)

(72) Inventors: Wentao Liao, Shenzhen (CN); Jian Zhang, Shenzhen (CN)

(21) Appl. No.: 19/302,309

(22) Filed: Aug. 18, 2025

(30) Foreign Application Priority Data
Sep. 11, 2024 (CN) 202411279430.1

(51) Int. Cl. A61H 15/02; A61H 7/00; A61H 15/00

(52) U.S. Cl. CPC A61H 15/02; A61H 7/007; A61H 2007/009; A61H 2015/0021; A61H 2015/005; A61H 2201/0207; A61H 2201/0221; A61H 2201/1207; A61H 2201/165; A61H 2201/1664; A61H 2205/04; A61H 2205/062

(57) ABSTRACT

A shoulder and neck massager includes a main body, a circuit board, two first massage mechanisms, a driving mechanism and a hot compress module. The first massage mechanisms and the hot compress module are arranged on the skin-proximal side of the main body. The circuit board and the driving mechanism are arranged in the main body. The driving mechanism is connected to the first massage mechanisms. When the two first massage mechanisms are driven by the driving mechanism to move towards or away from each other along the first direction, the skin-proximal side moves away from or close to the human body. The hot compress module performs hot compress on the massage part when the skin-proximal side is close to the human body.

### CROSS-REFERENCE TO RELATED APPLICATIONS

This disclosure claims all benefits accruing under 35 U.S.C. § 119 from Chinese Patent Application No. 202411279430.1 filed on Sep. 11, 2024, in China National Intellectual Property Administration, the entire disclosure of which is incorporated herein by reference.

### FIELD

The present disclosure relates to the technical field of massage equipment, and in particular to a shoulder and neck massager.

### BACKGROUND

In modern life, people daily activities usually involve sitting in front of the computer for a long time, using mobile phones for a long time as a “phubber”, or carrying out physical labors for a long time, all of which may cause shoulder and neck pain. As such, a massage device for hot compress and/or massage of the shoulder and neck has emerged as the times require.

In the related art, a massage device with a hot compress function generally comprises a host, a massage head arranged on the host, and a heating element arranged on the massage head. When massaging, the host is worn on the shoulder and neck of a human body, and the massage head is attached to the skin of the shoulder and neck of the human body to perform massage and hot compress. However, the above massage device adopts long-time hot compress on a massage part, which affects the user experience.

### SUMMARY

An embodiment of the present disclosure provides a shoulder and neck massage, which is used for improving the experience effect of hot compress massage when a user uses the shoulder and neck massage.

In order to achieve the above object, the present disclosure provides a shoulder and neck massage including a main body, a circuit board, two first massage mechanisms, a hot compress module, and a driving mechanism. The main body includes a skin-proximal side. The circuit board is arranged in the main body. The two first massage mechanisms are spaced apart from each other along a first direction and movably arranged on the skin-proximal side of the main body. The two first massage mechanisms are configured to massage the shoulder and neck of a human body. The hot compress module is arranged on the skin-proximal side, electrically connected with the circuit board, and located between the two first massage mechanisms. The driving mechanism is located in the main body, and electrically connected with the circuit board. The two first massage mechanisms are connected with the driving mechanism respectively. The driving mechanism is configured to drive the two first massage mechanisms to move close to or away from each other along the first direction, thereby driving the skin-proximal side and the hot compress module are close to or away from a massage part of the shoulder and neck of the human body.

### BRIEF DESCRIPTION OF THE DRAWINGS

In order to more clearly illustrate the technical solutions in the embodiments of the present disclosure, the following briefly introduces the drawings required in the embodiments. Obviously, the drawings in the following description merely show some embodiments of the present disclosure, and other drawings can be obtained by those of ordinary skill in the art without creative effort.

FIG. 1 is a structural schematic diagram of an embodiment of a shoulder and neck massage according to the present disclosure.

FIG. 2 is an exploded schematic diagram of an embodiment of a shoulder and neck massage according to the present disclosure.

FIG. 3 is a structural schematic diagram of an embodiment of a first massage mechanism according to the present disclosure.

FIG. 4 is a schematic diagram of an embodiment of a first connecting bracket in different states according to the present disclosure.

FIG. 5 is a schematic diagram of an embodiment of a branch part in a state according to the present disclosure.

FIG. 6 is a cross-sectional view of a part of a first connecting bracket taken along A-A in FIG. 3.

FIG. 7 is a structural schematic diagram of an embodiment of a second massage mechanism according to the present disclosure.

FIG. 8 is a structural schematic diagram of an embodiment of a driving mechanism according to the present disclosure.

FIG. 9 is a structural schematic diagram of an embodiment of an internal structure of a shoulder and neck massage according to the present disclosure.

FIG. 10 is a cross-sectional view of the internal structure of the shoulder and neck massage taken along B-B in FIG. 9.

FIG. 11 is an exploded schematic diagram of another embodiment of a shoulder and neck massage according to the present disclosure.

FIG. 12 is a structural schematic diagram of an embodiment showing a shoulder and neck massage on a shoulder and a neck of a human body according to the present disclosure.

### DETAILED DESCRIPTION

The technical solutions in the embodiments of the present disclosure will be clearly and completely described below with reference to the drawings in the embodiments of the present disclosure. Apparently, the described embodiments are only part but not all of the embodiments of the present disclosure. Based on the embodiments of the present disclosure, all other embodiments obtained by a person of ordinary skill in the art without creative effort should belong to the protective scope of the present disclosure.

In the present disclosure, the terms “inner”, “outer” and the like indicate the position or positional relationship based on the position or positional relationship shown in the drawings. These terms are mainly used to better describe the present disclosure and its embodiments, and not used to limit the indicated devices, elements or components to have a specific position, or to be constructed and operated in a specific position.

In addition, in addition to being used to indicate the position or positional relationship, the above-mentioned part of the terms can also be used to indicate other meanings, for example, the term “upper” can also be used to indicate a certain attachment relationship or connection relationship in some cases. For a person of ordinary skill in the art, the specific meaning of these terms in the present disclosure can be understood according to the specific circumstances.

In addition, the terms “mounted”, “disposed”, “provided with” and “connected” should be understood in a broad sense. For example, it can be a fixed connection, a detachable connection, an integral structure, a mechanical connection, an electrical connection;, a direct connection, an indirect connection through an intermediate medium, or an internal connection between two devices, elements or components. Those skilled in the art can understand the specific meanings of the above terms in the present disclosure according to specific circumstances.

In addition, the terms “first”, “second”, and the like are mainly used to distinguish different devices, elements or components (the specific types and structures can be the same or different), and are not used to indicate or imply the relative importance and the number of the indicated devices, elements or components. Unless otherwise specified, “a plurality of” means two or more.

The technical solutions of the present disclosure will be further described below in combination with the embodiments and the drawings.

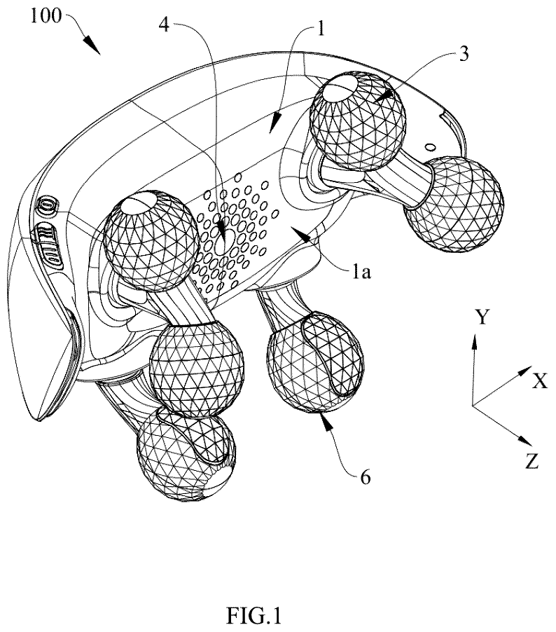

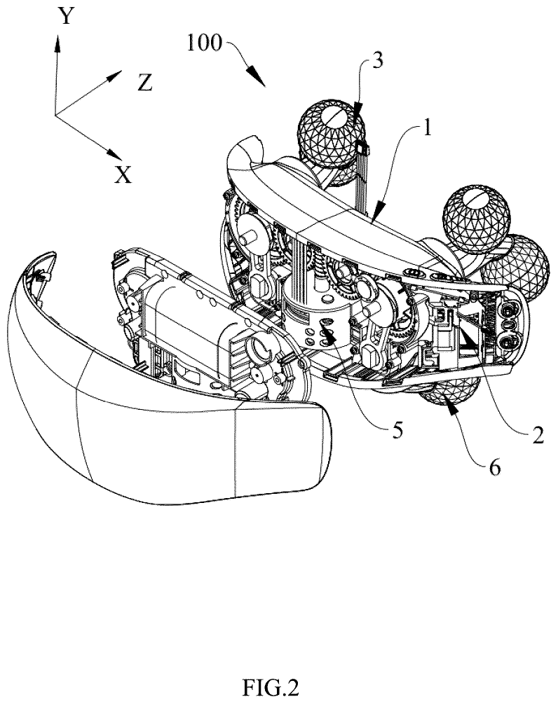

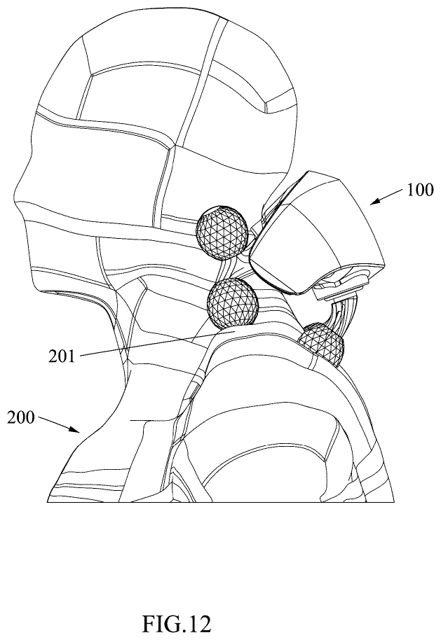

Referring to FIG. 1 and FIG. 2, the present disclosure provides a shoulder and neck massage 100, including a main body 1, a circuit board 2, two first massage mechanisms 3, a hot compress module 4 and a driving mechanism 5. The main body 1 includes a skin-proximal side 1a, and the circuit board 2 and the driving mechanism 5 are arranged in the main body 1. The two first massage mechanisms 3 are spaced apart from each other along a first direction and movably arranged on the skin-proximal side 1a of the main body 1, and the two first massage mechanisms are used for massaging the shoulder and neck 201 of a human body 200 (shown in FIG. 12). The hot compress module 4 is also arranged on the skin-proximal side 1a, electrically connected with the circuit board 2, and located between the two first massage mechanisms 3. The driving mechanism 5 is also electrically connected with the circuit board 2, and the two first massage mechanisms 3 are connected with the driving mechanism 5 respectively. The driving mechanism 5 is used for driving the two first massage mechanisms 3 to move close to or away from each other along the first direction, so that the skin-proximal side 1a and the hot compress module 4 are close to or away from a massage part of the shoulder and neck of the human body.

It can be understood that the shoulder and neck massage 100 of the present disclosure is worn on the shoulder and neck of the human body, and the two first massage mechanisms 3 are in contact with the neck and/or the shoulder of the human body when worn.

It can be understood that the skin-proximal side refers to a surface or a shell of a housing of the main body 1 of the shoulder and neck massage 100 which is closest to the human body when the shoulder and neck massage 100 is worn on the shoulder and neck of the human body.

The two first massage mechanisms 3 are driven by the driving mechanism 5 to move close to or away from each other along the first direction. When the shoulder and neck massager 100 is worn on the shoulder and neck of the human body, the two first massage mechanisms 3 move close to each other to support the main body 1, so that the skin-proximal side la of the main body 1 is away from the shoulder and neck of the human body, and the hot compress effect of the hot compress module 4 on the shoulder and neck of the human body is weakened. When the two first massage mechanisms 3 move away from each other, the two first massage mechanisms 3 lower the main body 1 towards the shoulder and neck of the human body, so that the skin-proximal side la of the main body 1 is close to the shoulder and neck of the human body, and the hot compress module 4 can perform hot compress on the shoulder and neck of the human body. As the two first massage mechanisms 3 move repeatedly in the above manner, the hot compress module 4 is switched between a state of being close to the shoulder and neck to hot compress and a state of being away from the shoulder and neck to hot compress, so that the hot compress module 4 does not generate a continuous burning sensation on the shoulder and neck of the human body, thereby avoiding the risk of low-temperature scald caused by long-time hot compress, and improving the comfort of wearing for the user.

In addition, when the two first massage mechanisms 3 are worn on the shoulder and neck of the human body and the two first massage mechanisms 3 move towards each other, the two first massage mechanisms 3 can support the main body 1 relative to the human body. In this way, a heat dissipation gap is naturally formed between the main body 1 and the shoulder and neck of the human body, and the heat generated by the hot compress module 4 can be dissipated through the heat dissipation gap, so as to reduce the accumulation of heat in the shoulder and neck of the human body, and keep the shoulder and neck in a better comfortable state.

It can be understood that, in the example shown in FIG. 1, a direction indicated by X is the first direction, and the first direction is a length direction of the main body 1 of the shoulder and neck massager 100. When the shoulder and neck massager 100 is worn on the shoulder and neck of the human body, the first direction can be a direction around the neck of the human body.

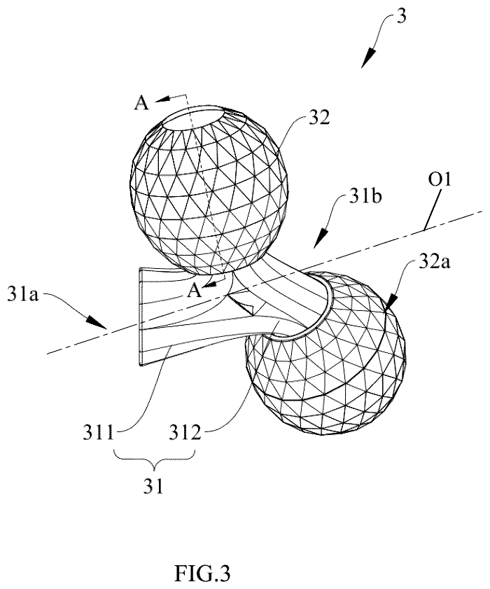

Referring to FIG. 3, in some embodiments, each of the two first massage mechanisms 3 includes a first connecting bracket 31 and a first massage head 32. The first connecting bracket 31 is connected to the driving mechanism 5, and the first massage head 32 is arranged at an end of the first connecting bracket 31 away from the skin-proximal side la. Axes of two first connecting brackets 31 of the two first massage mechanisms 3 are located on the same plane, and the axes of the two first connecting brackets 31 are inclined to each other. It can be understood that the first connecting bracket 31 connects the first massage head 32 and the skin-proximal side la of the main body 1, and the first massage head 32 is used to press or knead the shoulder and neck of the human body. In order to make the first massage mechanism 3 better adapt to a shape of the human body during massage, the axes of the first connecting brackets 31 of the two first massage mechanisms 3 are kept on the same plane during installation, so as to avoid misalignment of the two first connecting brackets 31 and prevent the massage from being uncomfortable due to asymmetry of massage areas on the shoulder and neck of the human body.

In some embodiments, the axes of the two first connecting brackets 31 are inclined to each other in the same plane, that is, the first connecting brackets 31 can be inclined toward each other or away from each other. Illustratively, when the two first connecting brackets 31 are inclined away from each other, the two first massage mechanisms 3 can be clamped on the shoulders or neck of the human body in an open state, and when the two first connecting brackets 31 are inclined toward each other, two first massage heads 32 of the two first massage mechanisms 3 can concentrate on massaging a specific area of the human body.

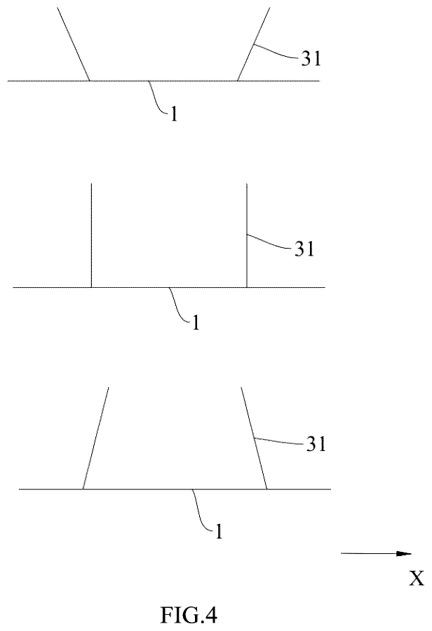

Referring to FIG. 4, in some embodiments, the first connecting bracket 31 includes a first end 31a and a second end 31b opposite to the first end 31a. The first end 31a is connected to the driving mechanism 5, and the first massage head 32 is arranged at the second end 31b. In some embodiments, a distance between the two first connecting brackets 31 in the first direction gradually increases along a direction from closer to the main body 1 to farther from the main body 1. In other words, two first ends 31a of the two first connecting brackets 31 are close to each other, and two second ends 31b of the two first connecting brackets 31 are away from each other. The two first connecting brackets 31 are inclined away from each other in the direction from closer to the main body 1 to farther from the main body 1, so that the two first massage mechanisms 3 can be better clamped on the shoulders or neck of the human body in the open state. In some embodiments, a distance between the two first connecting brackets 31 in the first direction gradually decreases in the direction from closer to the main body 1 to farther from the main body 1. In other words, the two first ends 31a of the two first connecting brackets 31 are away from each other, and the two second ends 31b of the two first connecting brackets 31 are close to each other. The two first connecting brackets 31 are inclined toward each other in the direction from closer to the main body 1 to farther from the main body 1, so that the two first massage heads 32 can concentrate on massaging the specific area of the human body, thereby improving the massage effect of the shoulder and neck massager 100.

In some embodiments, the first massage head 32 has a first massage surface 32a, and the first massage surface 32a may be a cambered surface. Since the first massage surface 32a is a cambered surface, when the first massage head 32 contacts the shoulder and neck of the human body, a touch feeling of the first massage surface 32a is relatively smooth, thereby preventing the first massage head 32 from scraping the skin of the human body.

In some embodiments, the first massage head 32 may be spherical or cylindrical. When the first massage head 32 is spherical or cylindrical, the first massage surface 32a of the first massage head 32 contacting the human body is relatively smooth, thereby preventing the first massage head 32 from scraping the skin of the human body during massage.

In some embodiments, the first massage surface 32a may be a diamond-cut surface. It can be understood that the diamond-cut surface has a plurality of ridge-shaped protrusions. Illustratively, the first massage surface 32a is provided with the plurality of ridge-shaped protrusions, and when the first massage surface 32a contacts the human body, the plurality of ridge-shaped protrusions can press the massage part of the shoulder and neck of the human body, thereby achieving a better massage effect.

The first massage surface 32a may also be provided with protrusions in the shapes of columns, cones, etc., which are not specifically limited herein.

To improve the massage effect of the shoulder and neck massager 100, in some embodiments, the first connecting bracket 31 may further include a trunk portion 311 and two branch portions 312. The trunk portion 311 is connected to the driving mechanism 5, the two branch portions 312 are both arranged on the trunk portion 311, and each first massage head 32 is connected to a respective one of the two branch portions 312. By increasing the number of the first massage heads 32, the shoulder and neck massager 100 can contact more parts of the human body. In this way, when the two first massage mechanisms 3 move close to each other, a plurality of first massage heads 32 can better knead or press the massage parts of the shoulder and neck of the human body.

In some embodiments, an end of each of the two branch portions 312 is arranged in a direction of an axis O1 of the trunk portion 311, the ends of the two branch portions 312 are sequentially arranged along the direction of the axis of the trunk portion 311, and the two branch portions 312 are respectively located on opposite sides of the axis of the trunk portion 311. It can be understood that the axial direction of the trunk portion 311 is an extension direction of its length. In other words, the ends of the two branch portions 312 are sequentially arranged along the extension direction of the trunk portion 311, and orientations of the two branch portions 312 are different from each other, that is, the two branch portions 312 extend in different directions from the trunk portion 311. In some embodiments, the orientations of the two branch portions 312 are opposite, that is, the two branch portions 312 extend in opposite directions from the trunk portion 311. In other embodiments, the orientations of the two branch portions 312 intersect, that is, the two branch portions 312 extend across each other. Due to the offset of the two branch portions 312, the first massage heads 32 are separated from each other, which prevents the shoulder and neck massager 100 from excessively concentrating on a single part when massaging the massage part of the human body, thereby improving the overall massage effect of the shoulder and neck massager 100.

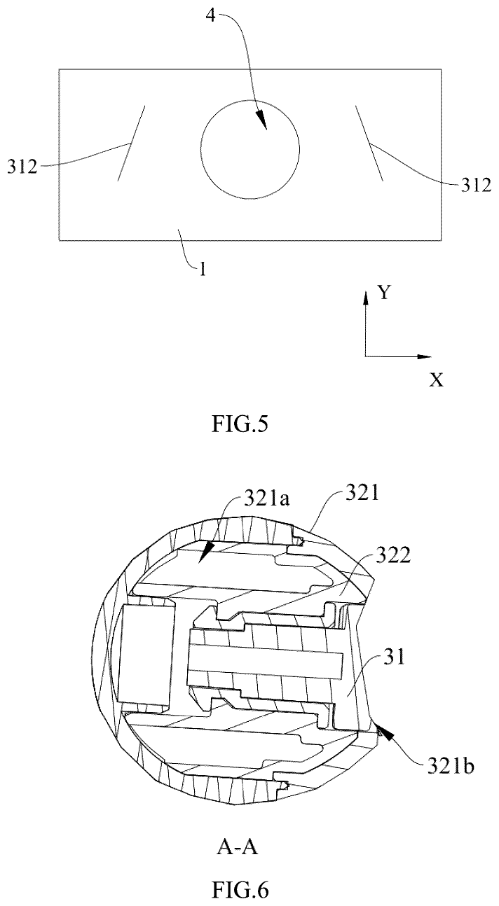

Referring to FIG. 5, in some embodiments, when the two branch portions 312 are opposite, along a second direction, two connecting lines of orientation directions of the two branch portions 312 of the two first connecting brackets 31 is inclined relative to the second direction, that is, the connecting line of the orientation directions of the two branch portions 312 of each of the two first connecting brackets 31 is inclined relative to the second direction. In some embodiments, the connecting lines of the orientation directions of the two branch portions 312 of the two first connecting brackets 31 are distributed in a shape of “□”, “□” is shaped like the Chinese capital number “eight”. When viewed from the back of the human body, the transition arc of opposite sides of the neck to the shoulders of the human body is also in the shape of “□”. In this way, when the two first connecting brackets 31 are massaged, the two branch portions 312 of the two first connecting brackets 31 can be adapted to the shape of the shoulder and neck of the human body, which is conducive to wearing the shoulder and neck massager 100 on the shoulder and neck of the human body.

It should be noted that in the example shown in FIG. 5, a direction indicated by Y is the second direction, the second direction can be a width direction of the main body 1. When the shoulder and neck massager 100 is worn on the human body, the second direction can also be an extension direction of the neck of the human body, and the second direction intersects with the first direction.

Referring to FIG. 6, in some embodiments, the first massage head 32 may include a massage shell 321 and an internal support 322. The massage shell 321 has a mounting space 321a and a mounting hole 321b communicating with the mounting space 321a. The first connecting bracket 31 extends through the mounting hole 321b and enters the mounting space 321a. The internal support 322 is arranged in the mounting space 321a and located at an outer periphery of the first connecting bracket 31. That is, the massage shell 321 is internally hollow. The first connecting bracket 31 and the internal support 322 are arranged in the mounting space 321a. The internal support 322 supports the massage shell 321 in the mounting space 321a, thereby enhancing the structural strength of the massage shell 321 and preventing the massage shell 321 from being squeezed or pressed to be damaged when kneading or pressing the human body.

In some embodiments, the massage shell 321 may be made of a hard material, and the internal support 322 may be made of a flexible material. Because the massage shell 321 is made of the hard material, the shoulder and neck massager 100 has a good pressing or kneading effect on the human body when the massage shell 321 contact the human body. The flexible internal support 322 has a good deformation effect when the massage shell 321 contacts the human body, thereby preventing the hollow massage shell 321 from being squeezed or pressed to be damaged when the massage shell 321 contacts the human body to be kneaded or pressed. Moreover, the internal support 322 is made of the flexible material, so that the massage shell 321 can deform along with the massage part during the massage process, thereby enabling the massage shell 321 to better fit the massage part and improving the massage effect of the massage shell 321 on the massage part.

In some embodiments, the internal support 322 may be a support such as an elastic piece, a spring, a rubber, a sponge or the like, which is not specifically limited herein.

Referring to FIGS. 1 and 2 again, considering that the shoulder and neck massager 100 needs to simultaneously consider neck massage and shoulder massage, in some embodiments, the shoulder and neck massager 100 may further include two second massage mechanisms 6. The two second massage mechanisms 6 are arranged on the skin-proximal side 1a of the main body 1, and the two second massage mechanisms 6 are spaced apart from each other along the first direction. Each of the second massage mechanisms 6 is arranged corresponding to and spaced apart from one of the two first massage mechanisms 3 along the second direction. In a first example, when the shoulder and neck massager 100 is worn on the shoulder and neck of the human body, the two first massage mechanisms 3 can be located on both sides of the neck of the human body along the first direction respectively, and the two second massage mechanisms 6 can be located on both sides of the shoulder of the human body along the first direction respectively. In a second example, the two first massage mechanisms 3 can be located on both sides of the shoulder of the human body along the first direction respectively, and the two second massage mechanisms 6 can be located on both sides of the neck of the human body along the first direction respectively. In a third example, each of the two first massage mechanism 3 is located at a junction of the shoulder and the neck of the human body, and each of the two second massage mechanisms 6 is located on the side of a corresponding first massage mechanism 3 of the two first massage mechanisms 3 close to the neck or close to the shoulder. In the shoulder and neck massager 100 disclosed in the disclosure, when each of the two first massage mechanisms 3 are massaging one of the shoulder and the neck of the human body, each of the two second massage mechanisms 6 can massage the other one, so as to simultaneously massage both the shoulder and the neck of the human body, or when the two first massage mechanisms 3 are massaging the shoulder and neck of the human body, the two second massage mechanisms 6 can assist the two first massage mechanisms 3 to massage. In this way, the two second massage mechanisms 6 of the disclosure enables the shoulder and neck massager 100 to simultaneously massage the shoulder and the neck, and can also assist the two first massage mechanisms 3 to massage the shoulder or the neck, thereby improving the massage effect of the shoulder and neck massager 100 on the shoulder and neck of the human body.

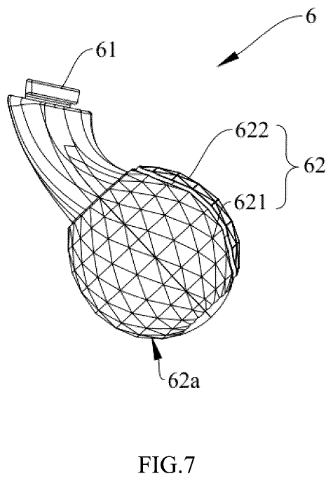

Referring to FIG. 7, in some embodiments, each of the two second massage mechanisms 6 includes a second connecting bracket 61 and a second massage head 62. The second connecting bracket 61 is connected to the driving mechanism 5, and the second massage head 62 is arranged at an end of the second connecting bracket 61 away from the skin-proximal side la. In addition, axes of the two second connecting brackets 61 are located in the same plane, and the axes of the two second connecting brackets 61 are parallel to each other. The second massage mechanism 6 of the disclosure separates the second massage head 62 from the skin-proximal side la through the second connecting bracket 61, and when the second massage head 62 massages the human body, it is equivalent to that the second connecting bracket 61 supports the skin-proximal side 1a relative to the massage part of the human body, so that a heat dissipation channel is also formed between the two second massage mechanisms 6, which is conducive to the heat generated by the hot compress module 4 dissipating from between the two second massage mechanisms 6.

In order to improve the massage effect of the second massage head 62 on the human body, the second massage head 62 may have a second massage surface 62a, which can also be provided as a diamond-cut surface. It can be understood that the diamond-cut surface has a plurality of ridge-shaped protrusions. Exemplarily, the second massage surface 62a is provided with the plurality of ridge-shaped protrusions, and when the second massage surface 62a is in contact with the human body, the ridge-shaped protrusions can press the massage part of the human shoulder and neck, thereby achieving a better massage effect.

In order to allow the second massage head 62 to have better comfort when in contact with the human body, the second massage head 62 may include a hard shell 621 and a soft shell 622. The soft shell 622 is connected to the hard shell 621 to form a shell part of the second massage head 62, and the soft shell 622 is configured to be in contact with the massage part of the shoulder and neck part of the human body. Since the material of the soft shell 622 is relatively soft, when the soft shell 622 is in contact with the human body and the second massage mechanism 6 is massaging the human shoulder and neck, the soft shell 622 of the second massage head 62 is not easy to cause injury to the shoulder and neck of the human body, so that the second massage head 62 has better comfort when in contact with the human body.

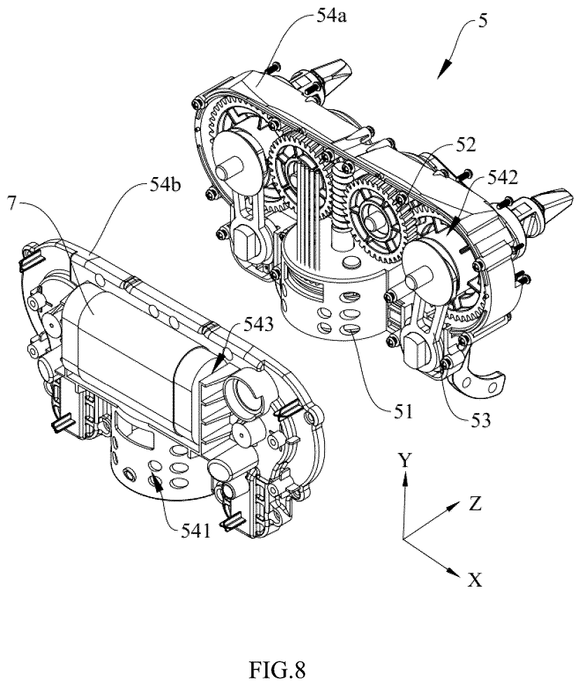

Referring to FIG. 8, in some embodiments, the driving mechanism 5 includes a motor 51 and two first transmission structures 52, the two first transmission structures are both connected to the motor 51. The first transmission structures 52 are respectively connected to the two first massage mechanisms 3. The two first transmission structures 52 are configured to drive the two first massage mechanisms 3 to move away from or close to each other along the first direction under the action of the motor 51. In other words, the first massage mechanism 3 can massage the human body under the driving of the first transmission structure 52 of the driving mechanism 5, and the second massage mechanism 6 may not be connected to the driving mechanism 5. When the first massage mechanism 3 massages, the skin-proximal side 1a moves away from or close to the massage part of the human body, and the second massage mechanism 6 located on the skin-proximal side 1a moves along with the movement of the skin-proximal side 1a. That is, the second massage mechanism 6 passively massages the shoulder and neck of the human body. In this way, a transmission structure of the driving mechanism 5 is reduced, which is conducive to the lightweight design of the shoulder and neck massager 100 and reduces the burden on the shoulder and neck of the human body when the shoulder and neck massager 100 is worn on the shoulder and neck of the human body.

Exemplarily, the motor 51 outputs power in the second direction, and the first transmission structure 52 connected to a power output shaft of the motor 51 converts the power output by the motor 51 in the second direction into power output in the first direction. In this way, the first massage mechanism 3 can move along the first direction.

In some embodiments, the second massage mechanism 6 is movably arranged on the skin-proximal side 1a, and the two second massage mechanisms 6 are configured to move in the second direction to approach or move away from the corresponding first massage mechanism 3. For example, the shoulder and neck massager 100 may include two driving mechanisms 5, and the second massage mechanism 6 can independently adopt one of the two driving mechanisms 5, so that the second massage mechanism 6 can independently move relative to the first massage mechanism 3. The disclosure enables the second massage mechanism 6 to also be movable, and the first massage mechanism 3 and the second massage mechanism 6 form a dual-movable massage mechanism. Two massage mechanisms can be simultaneously actively movable to better massage the shoulder and neck of the human body, thereby improving the massage effect.

In some embodiments, the driving mechanism 5 may further include two second transmission structures 53, each of the two second transmission structures 53 are connected to a corresponding one of the two first transmission structures 52, and the two second transmission structures 53 are connected to a corresponding one of the two second massage mechanisms 6. The second transmission structure 53 is configured to drive the second massage mechanism 6 to move away from or approach the corresponding first massage mechanism 3 in the second direction when the two first massage mechanisms 3 move close to or away from each other in the first direction. The second massage mechanisms 6 disclosed by the disclosure can also be driven by another two second transmission structures 53, and each of the another two second transmission structures 53 are in linkage motion with a corresponding one of the first transmission structures 52. In this way, the second massage mechanism 6 can be driven without additionally adding another driving mechanism 5, the first massage mechanism 3 and the second massage mechanism 6 adopt the same motor 51 as the power source, thereby reducing the overall weight of the shoulder and neck massager 100 and facilitating reduction of the burden of the shoulder and neck massager 100 on the shoulder and neck of the human body when the shoulder and neck massager 100 is worn on the human body.

In some embodiments, the first transmission structure 52 and the second transmission structure 53 may be a gear transmission mechanism, a connecting rod transmission mechanism, or a transmission mechanism composed of a gear and a connecting rod, and the disclosure does not make specific limitation here.

Since the driving mechanism 5 may be composed of the motor 51, the two first transmission structures 52, and the two second transmission structures 53, in order to improve the compactness of the overall internal structure of the shoulder and neck massager 100, in some embodiments, in the first direction, the motor 51 is located in the middle of the main body 1, the two first transmission structures 52 are respectively located on the two sides of the motor 51, and the two second transmission structures 53 are also respectively located on the two sides of the motor 51. In the second direction, each of the two second transmission structures 53 are arranged corresponding to one of the two first transmission structures 52. In other words, the motor 51, which is heavier in the driving mechanism 5, is distributed in the middle area of the shoulder and neck massager 100, and the remaining transmission structures are evenly arranged on the two sides of the motor 51, so that the overall weight of the shoulder and neck massager 100 is more balanced, which will not cause one side to be heavier or lighter. In this way, the overall comfort is better when people wear the shoulder and neck massager 100.

In some embodiments, the driving mechanism 5 may further include a mounting housing 54, the mounting housing 54 has a first mounting cavity 541 and two second mounting cavities 542 in the first direction, the two second mounting cavities 542 are located on opposite sides of the first mounting cavity 541, the motor 51 is arranged in the first mounting cavity 541, each of the two first transmission structures 52 are arranged in a corresponding one of the two second mounting cavities 542, and each of the two second transmission structures 53 are arranged in a corresponding one of the two second mounting cavities 542, so that the first transmission structure 52 and the second transmission structure 53 are integrally mounted in the second mounting cavity 542. Through the mounting housing 54, the motor 51, the first transmission structure 52 and the second transmission structure 53 of the driving mechanism 5 are integrally installed in the main body 1 of the shoulder and neck massage 100, so that the compactness of the internal space of the main body 1 may be improved.

In some embodiments, the shoulder and neck massage 100 may further include a battery 7, the mounting housing 54 may further have a third mounting cavity 543, the third mounting cavity 543 is located in the mounting housing 54, and the battery 7 is arranged in the third mounting cavity 543, so that the battery 7 is integrally arranged with the driving mechanism 5. In order to improve the convenience of use of the shoulder and neck massage 100, the battery 7 is provided in the shoulder and neck massage 100, so that the shoulder and neck massage can be worn and used at any time and anywhere. In addition, since the battery 7 is provided in the shoulder and neck massage 100, in order to improve the compactness of the internal structure of the shoulder and neck massage 100, the battery 7 is mounted in the third mounting cavity 543 of the mounting housing 54, so that the battery 7 is integrally arranged with the driving mechanism 5, and the internal structure of the shoulder and neck massage 100 is more compact.

In order to facilitate the disassembly and assembly of the motor 51, the first transmission structure 52 and the second transmission structure 53 in the mounting housing 54, the mounting housing 54 may include a first sub-housing 54a and a second sub-housing 54b, the first sub-housing 54a is connected to the second sub-housing 54b to form the first mounting cavity 541 and the second mounting cavity 542, the first sub-housing 54a is arranged closer to the skin-proximal side 1a than the second sub-housing 54b, and the third mounting cavity 543 is arranged on a side of the second sub-housing 54b facing away from the first sub-housing 54a. In a first example, the first transmission structure 52, the second transmission structure 53 and the motor 51 can be mounted on the first sub-housing 54a, and then the second sub-housing 54b is buckled to the first sub-housing 54a for assembly. In a second example, the first transmission structure 52, the second transmission structure 53 and the motor 51 can be mounted on the second sub-housing 54b, and then the first sub-housing 54a is buckled to the second sub-housing 54b for assembly. In a third example, the motor 51 is mounted on the first sub-housing 54a, the first transmission structure 52 and the second transmission structure 53 are mounted on the second sub-housing 54b, and finally the first sub-housing 54a and the second sub-housing 54b are buckled and mounted. In a fourth example, the motor 51 is mounted on the second sub-housing 54b, the first transmission structure 52 and the second transmission structure 53 are mounted on the first sub-housing 54a, and finally the first sub-housing 54a and the second sub-housing 54b are buckled and mounted. The disclosure divides the mounting housing 54 into the first sub-housing 54a and the second sub-housing 54b, respectively mounts the motor 51, the first transmission structure 52 and the second transmission structure 53 in the mounting housing 54 and mount the first sub-housing 54a and the second sub-housing 54b to form the driving mechanism 5, and then mounts the driving mechanism 5 into the main body 1 of the shoulder and neck massager 100, thereby facilitating the overall mounting convenience of the driving mechanism 5 and the shoulder and neck massager 100.

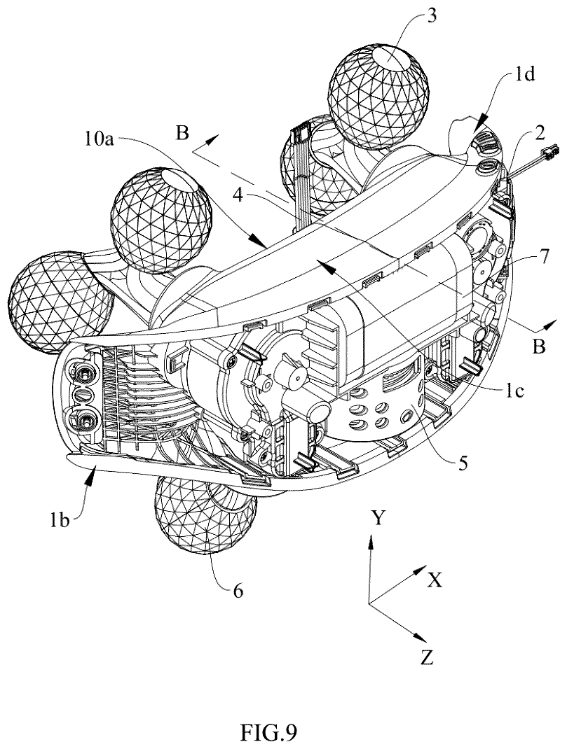

Referring to FIG. 9, in some embodiments, the main body 1 includes a first edge portion 1b, a middle portion 1c and a second edge portion 1d arranged in sequence in the first direction, the driving mechanism 5, the battery 7 and the hot compress module 4 of the shoulder and neck massager 100 are arranged in the middle portion 1c, and the circuit board 2 is arranged in the first edge portion 1b or the second edge portion 1d. The first edge portion 1b and the second edge portion 1d may be inclined relative to the middle portion 1c, and an inclination direction of the first edge portion 1b intersects an inclination direction of the second edge portion 1d.

In a first aspect, the driving mechanism 5 and the battery 7 have relatively large weights. By arranging the driving mechanism 5 and the battery 7 in the middle portion 1c, a center of gravity of the shoulder and neck massager 100 is located in the middle portion, and the overall structure and weight of the shoulder and neck massager 100 are more balanced. Since the hot compress module 4 is also located in the middle portion 1c of the main body 1, when the hot compress module 4 performs hot compress on the shoulder and neck of the human body, the middle portion 1c is a region where the center of gravity of the shoulder and neck massager 100 is located, which is conducive to better pressing the skin-proximal side 1a on the shoulder and neck, thereby improving the hot compress effect of the hot compress module 4.

In a second aspect, the driving mechanism 5, the battery 7, and the hot compress module 4 will generate a large amount of heat during operation. By arranging the circuit board 2 in the first edge portion 1b or the second edge portion 1d to offset the circuit board 2 from these structures that generate the large amount of heat, so that the structures that generate the large amount of heat do not affect the normal operation of the circuit board 2.

In a third aspect, the first edge portion 1b and the second edge portion 1d are inclined relative to the middle portion 1c. In some embodiments, the first edge portion 1b and the second edge portion 1d may be inclined toward the middle portion 1c. When the shoulder and neck massager 100 is worn on the human body, the middle portion 1c corresponds to the neck of the human body, and the first edge portion 1b and the second edge portion 1d are wrapped on both sides of the neck. In this way, when the shoulder and neck massager 100 is worn on the shoulder and neck of the human body, the shoulder and neck massager 100 can have better wrapping performance on the neck, and the wearing comfort can be improved.

In some embodiments, the skin-proximal side 1a has a skin-close surface 10a, and a projection of the driving mechanism 5 and/or the battery 7 on the skin-close surface 10a in a third direction at least partially corresponds to a projection of the hot compress module 4 on the skin-close surface in the third direction. In order to further improve the hot compress effect of the hot compress module 4 on the shoulder and neck of the human body, the driving mechanism 5 is arranged in correspondence with the hot compress module 4, so that the overall center of gravity of the shoulder and neck massager 100 is concentrated on the hot compress module 4. Therefore, when the hot compress module 4 is used for hot compress on the shoulder and neck of the human body, the skin-proximal side 1a can be better attached to the massage part of the shoulder and neck of the human body.

It should be noted that, in the example shown in FIG. 9, a direction indicated by Z is the third direction, the third direction can be a thickness direction of the shoulder and neck massager 100, and the third direction intersects with the first direction and the second direction.

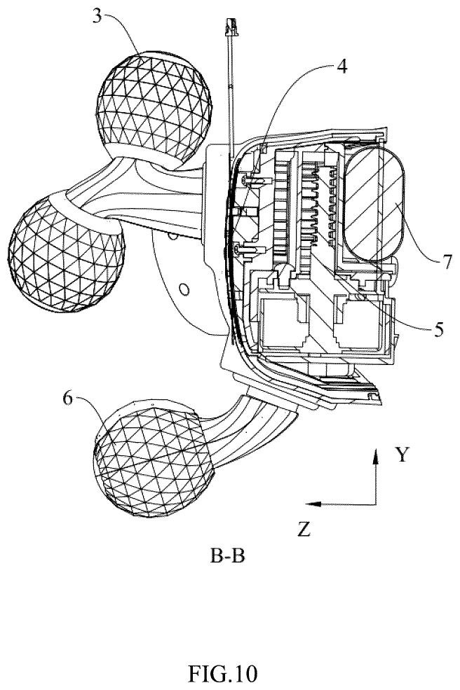

Referring to FIG. 10, in order to avoid the heat generated by the driving mechanism 5 and the battery 7 during operation from affecting the hot compress module 4 and causing uneven hot compress temperature, the hot compress module 4 is arranged at a distance from the driving mechanism 5 and/or the battery 7 in the third direction. That is, the battery 7 and the driving mechanism 5 are respectively spaced apart from the hot compress module 4 in the main body 1, so that heat generated by the battery 7 and the driving mechanism 5 is prevented from being transferred to the hot compress module 4.

In order to avoid the hot compress module 4 from directly acting on the skin of the human body during hot compress, the main body 1 may include a first shell 11 and a second shell 12. The first shell 11 is connected to the second shell 12 to form an accommodation space. The first shell 11 includes the skin-proximal side 1a. The hot compress module 4 is arranged in the accommodation space. The driving mechanism 5, the battery 7, and the circuit board 2 are also located in the accommodation space. The heat of the hot compress module 4 is transferred to the skin-proximal side 1a. When the skin-proximal side 1a is attached to the shoulder and neck of the human body, the shoulder and neck of the human body are hot compressed through the skin-proximal side 1a, so that the hot compress module 4 is prevented from directly hot compressing the shoulder and neck of the human body.

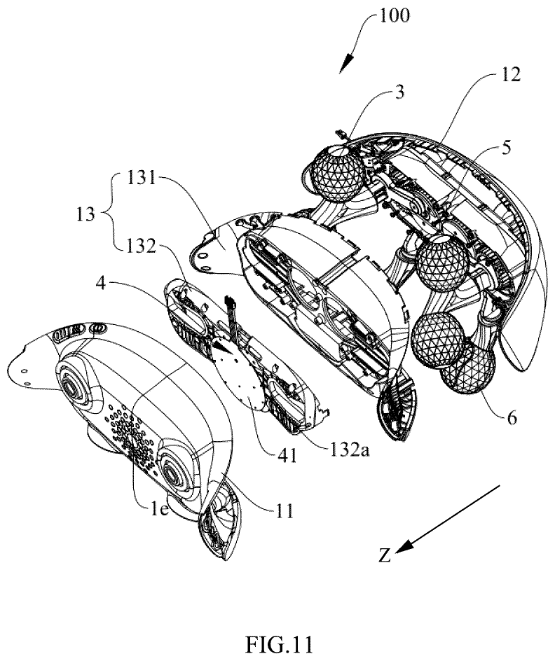

Referring to FIGS. 10 and 11, in some embodiments, in order to further avoid the heat generated by the driving mechanism 5 and the battery 7 from affecting the hot compress module 4 and causing uneven hot compress temperature of the hot compress module 4, the main body 1 may further include a heat insulation structure 13, the heat insulation structure 13 is arranged in the accommodation space, and the hot compress module 4 is located on one side of the heat insulation structure 13 along the third direction, and the driving mechanism 5 and/or the battery 7 are located on the other sides of the heat insulation structure 13 along the third direction. The battery 7 and the driving mechanism 5 are spaced apart from the hot compress module 4 in the main body 1 by the heat insulation structure 13, so that heat generated by the driving mechanism 5 and the battery 7 is prevented from being transferred to the hot compress module 4, and the influence of the battery 7 and the driving mechanism 5 on the working of the hot compress module 4 is effectively avoided. Exemplarily, the battery 7 and the driving mechanism 5 may also be spaced apart from the heat insulation structure 13, so that the heat generated by the driving mechanism 5 and the battery 7 transferred to the heat insulation structure 13 is effectively reduced, and the influence on the hot compress module 4 is reduced.

In some embodiments, the heat insulation structure 13 includes a heat insulation shell 131 and a heat dissipation shell 132, the heat insulation shell 131 and the heat dissipation shell 132 are arranged along the third direction. The heat dissipation shell 132 is connected to a side of the heat insulation shell 131 facing the first shell 11, the driving mechanism 5 and/or the battery 7 are arranged on a side of the heat insulation shell 131 away from the heat dissipation shell 132, and the hot compress module 4 is arranged on the heat dissipation shell 132. The heat dissipation shell 132 is provided with a plurality of heat dissipation ribs 132a, and the plurality of heat dissipation ribs 132a are at least partially arranged corresponding to the hot compress module 4. Exemplarily, the driving mechanism 5 and the battery 7 are arranged on the side of the heat insulation shell 131 away from the heat dissipation shell 132, and the heat insulation shell 131 blocks the heat generated by the driving mechanism 5 and the battery 7, so that the heat generated by the driving mechanism 5 and the battery 7 is prevented from being transferred to the heat dissipation shell 132. Each of the heat dissipation ribs 132a on the heat dissipation shell 132 extends along the first direction, the heat dissipation ribs 132a can guide the heat generated by the hot compress module 4 out along the first direction, so that the heat generated by the hot compress module 4 and the heat generated by the battery 7 and the driving mechanism 5 are prevented from accumulating in the accommodation space, and the working of electronic components in the accommodation space is prevented from being affected by excessive heat.

In some embodiments, the hot compress module 4 includes a circuit board 41 and a plurality of heating elements (not shown), and the plurality of heating elements are arranged in an array on the circuit board 41. By arranging the heating elements in an array on the circuit board 41, the hot compress module 4 can be heated more uniformly when performing hot compress on the shoulder and neck of the human body, and the hot compress effect is improved.

In some embodiments, each heating element may be arranged in a circular array, a square array or the like, which is not specifically limited herein.

In some embodiments, the hot compress module 4 may be arranged in the main body 1, the heating element may be a heating lamp bead, the skin-proximal side 1a is provided with a light outlet hole 1e, and the heating lamp bead heats the massage part of the shoulder and neck of the human body through the light outlet hole 1e. In order to avoid direct heating of the human body by the hot compress module 4, the hot compress module 4 is arranged in the main body 1, and the heating lamp bead is used as a heating source to heat the massage part of the shoulder and neck of the human body by using the heat radiation generated by the heating lamp bead. The heating lamp bead not only has uniform and soft heating effect, but also can heat the human body in a spaced manner, thereby preventing discomfort caused by direct contact of the human body with the heating lamp bead.

In order to improve the comfort of wearing the shoulder and neck massager 100 on the shoulder and neck of the human body, in some embodiments, the skin-proximal side 1a is made of a flexible material. It can be understood that the skin-proximal side 1a is a side of the main body 1 close to the human body. When the shoulder and neck massager 100 is worn on the human body, the skin-proximal side la alternately approaches or moves away from the human body with the movement of the two first massage mechanisms 3. Such repeated contact with the human body, when the skin-proximal side la adopts a flexible material, the discomfort of contact with the human body is reduced, which is conducive to improving the wearing comfort of the shoulder and neck massager 100.

In some embodiments, the flexible material may be silica gel, skin-friendly fabric, etc., which is not specifically limited herein.

In some embodiments, the shoulder and neck massager 100 may further include a wearing part (not shown), the wearing part is connected to opposite ends of the main body 1 along the first direction, and the wearing part is configured to wear the main body 1 on the shoulder and neck of the human body. In order to prevent the user from falling the shoulder and neck massager 100 when using the shoulder and neck massager 100, the main body 1 of the shoulder and neck massager 100 is worn on the human body by the wearing part to prevent the main body 1 from falling.

In some embodiments, the wearing part may be a wrap-around strap, a Velcro strap, etc., which is not specifically limited herein.

The above detailed description of the embodiments of the shoulder and neck massager disclosed in the present application is provided, and the principle and implementation mode of the present disclosure are described by using specific examples in the text. The above description of the embodiments is only used to help understand the shoulder and neck massager and the core idea thereof. Meanwhile, for those skilled in the art, the specific implementation mode and disclosure range can be changed according to the idea of the present disclosure. In conclusion, the content of the specification should not be understood as a limitation on the present disclosure.

What is claimed is:

1. A shoulder and neck massager, comprising:
a main body having a skin-proximal side;
a circuit board arranged in the main body;
two first massage mechanisms spaced apart from each other along a first direction and movably arranged on the skin-proximal side of the main body, the two first massage mechanisms configured to massage shoulders and a neck of a human body;
a hot compress module arranged on the skin-proximal side, the hot compress module electrically connected with the circuit board and located between the two first massage mechanisms; and
a driving mechanism arranged in the main body and electrically connected with the circuit board, wherein each of the two first massage mechanisms is connected with the driving mechanism, the driving mechanism is configured to drive the two first massage mechanisms to move towards or away from each other along the first direction, thereby driving the skin-proximal side of the main body and the hot compress module to move towards or away from a massage part of the shoulder and neck of the human body.

2. The shoulder and neck massager of claim 1, wherein each of the two first massage mechanisms comprises a first connecting bracket on the main body and a first massage head connecting the first connecting bracket, the first connecting bracket is connected with the driving mechanism, the first massage head is arranged at an end of the connecting first connecting bracket away from the skin-proximal side;
axes of two first connecting brackets of the two first massage mechanisms are co-planar, and the axes of the two first connecting brackets are inclined relative to each other.

3. The shoulder and neck massager of claim 2, wherein each of the two first connecting brackets has a first end and a second end opposite to the first end, the first end is connected to the driving mechanism, and the first massage head is arranged at the second end;
a distance between the two first connecting brackets in the first direction gradually increases along a direction from closer to the main body to farther from the main body.

4. The shoulder and neck massager of claim 2, wherein each of the two first connecting brackets comprises a trunk portion and two branch portions, the trunk portion is connected with the driving mechanism, the two branch portions are arranged on the trunk portion, and each of the two branch portions is connected with the first massage head.

5. The shoulder and neck massager of claim 4, wherein an end of each of the two branch portions is arranged in a direction of an axis of the trunk portion, the ends of the two branch portions are sequentially arranged along the direction of the axis of the trunk portion, and the two branch portions are respectively located on two sides of the axis of the trunk portion.

6. The shoulder and neck massager of claims 1, wherein the driving mechanism comprises a motor and two first transmission structures, each of the two first transmission structures is connected with the motor, each of the two first transmission structures is connected to a corresponding first massage mechanism of the two first massage mechanisms, and the two first transmission structures are driven by the motor to drive the two first massage mechanisms to move towards or away from each other along the first direction.

7. The shoulder and neck massager of claim 6, further comprising two second massage mechanisms, wherein the two second massage mechanisms are disposed on the skin-proximal side, the two second massage mechanisms are spaced apart along the first direction, and each of the two second massage mechanisms is arranged corresponding to one of the two first massage mechanisms along a second direction;
the second direction intersects with the first direction.

8. The shoulder and neck massager of claim 7, wherein the two second massage mechanisms are movably disposed on the skin-proximal side, and each of the two second massage mechanisms is configured to move towards or away from the corresponding one of the two first massage mechanisms along the second direction.

9. The shoulder and neck massager of claim 8, wherein the driving mechanism further comprises two second transmission structures, each of the two second transmission structures are connected to a corresponding one of the two first transmission structures, and each of the two second transmission structures are connected to a corresponding one of the two second massage mechanisms;
each of the two second transmission structures is configured to drive the corresponding one of the two second massage mechanisms to move away from or towards the corresponding one of the two first massage mechanisms along the second direction when the two first massage mechanisms move towards or away from each other along the first direction.

10. The shoulder and neck massager of claim 9, wherein along the first direction, the motor is located in a middle portion of the main body, the two first transmission structures are respectively located at opposite sides of the motor, and the two second transmission structures are respectively located at the opposite sides of the motor; and
along the second direction, each of the two second transmission structures corresponds to one of the two first transmission structures.

11. The shoulder and neck massager of claim 10, wherein the driving mechanism further comprises a mounting housing, the mounting housing comprises a first mounting cavity and two second mounting cavities, the two second mounting cavities are respectively located on opposite sides of the first mounting cavity along the first direction, the motor is arranged in the first mounting cavity, and each of the two first transmission structures is arranged in a corresponding one of the two second mounting cavities; and
each of the two second transmission structures is arranged in a corresponding one of the two second mounting cavities.

12. The shoulder and neck massager of claim 11, further comprising a battery, wherein the mounting housing further has a third mounting cavity, the third mounting cavity is located in the mounting housing, on a side away from the first mounting cavity and one of the two second mounting cavities, and the battery is arranged in the third mounting cavity.

13. The shoulder and neck massager of claim 12, wherein the mounting housing comprises a first sub-housing and a second sub-housing, the first sub-housing is connected to the second sub-housing to enclose the first mounting cavity and the two second mounting cavities, the first sub-housing is arranged close to the skin-proximal side, and the third mounting cavity is arranged on a side of the second sub-housing away from the first sub-housing.

14. The shoulder and neck massager of claim 1, further comprising two second massage mechanisms, wherein the two second massage mechanisms are arranged on the skin-proximal side, the two second massage mechanisms are spaced apart from each other along the first direction, and each of the two second massage mechanisms is arranged corresponding to and spaced apart from one of the two first massage mechanisms along a second direction;
the second direction intersects with the first direction.

15. The shoulder and neck massager of claim 14, wherein each of the two second massage mechanisms further comprises a second connecting bracket and a second massage head, the second connecting bracket is connected to the driving mechanism, and the second massage head is arranged at an end of the second connecting bracket away from the skin-proximal side;
each of the two second connecting brackets defines an axis, the axes of the two second connecting brackets are co-planar, and the axes of the two second connecting brackets are parallel to each other.

16. The shoulder and neck massager of claim 12, wherein the main body comprises a first edge portion, a middle portion and a second edge portion arranged in sequence along the first direction, the driving mechanism, the battery and the hot compress module are arranged in the middle portion, and the circuit board is arranged in the first edge portion or the second edge portion;
the first edge portion and the second edge portion are respectively inclined relative to the middle portion, and an inclination direction of the first edge portion intersects with an inclination direction of the second edge portion.

17. The shoulder and neck massager of claim 16, wherein the skin-proximal side has a skin-close surface, and a projection of at least one of the driving mechanism and the battery on the skin-close surface along a third direction at least partially corresponds to a projection of the hot compress module on the skin-close surface along the third direction;
the third direction intersects with the first direction.

18. The shoulder and neck massager of claim 16, wherein the main body comprises a first shell and a second shell, the first shell is connected to the second shell to form an accommodation space, the first shell has the skin-proximal side, and the hot compress module is arranged on a side of the skin-proximal side facing the accommodation space and located in the accommodation space.

19. The shoulder and neck massager of claim 17, wherein the main body further comprises a heat insulation structure, the heat insulation structure is arranged in the accommodation space, and the hot compress module is located on one side of the heat insulation structure along the third direction, and the driving mechanism and/or the battery are located on other sides of the heat insulation structure along the third direction;
the third direction intersects with the first direction.

20. The shoulder and neck massager of claim 19, wherein the heat insulation structure comprises a heat insulation shell and a heat dissipation shell along the third direction, the heat dissipation shell is connected to a side of the heat insulation shell facing the first shell, at least one of the driving mechanism and the battery is arranged on a side of the heat insulation shell facing away from the heat dissipation shell, the hot compress module is arranged on the heat dissipation shell, and the heat dissipation shell is provided with a plurality of heat dissipation ribs, and the plurality of heat dissipation ribs are arranged at least partially corresponding to the hot compress module.
